(19) United States
(12) Patent Application Publication
(10) Pub. No.: US 2017/0178202 A1
(43) Pub. Date: Jun. 22, 2017

(54) Advertisement display method, terminal device and a non-transitory computer-readable storage medium

(71) Applicants: Le Holdings (Beijing) Co., Ltd., Beijing (CN); LE SHI INTERNET INFORMATION&TECHNOLOGY CORP., BEIJING, Beijing (CN)

(72) Inventor: Kaili XU, Beijing (CN)

(21) Appl. No.: 15/242,158

(22) Filed: Aug. 19, 2016

Related U.S. Application Data
(63) Continuation of application No. PCT/CN2016/088647, filed on Jul. 5, 2016.

(30) Foreign Application Priority Data
Dec. 17, 2015 (CN) 2015109541892

(51) Int. Cl. G06Q 30/02; H04N 21/458; H04N 21/222; H04N 21/443; H04N 21/81; H04N 21/61

(52) U.S. Cl. CPC G06Q 30/0277; H04N 21/812; H04N 21/6125; H04N 21/2223; H04N 21/4432; H04N 21/458

(57) ABSTRACT

The present disclosure discloses an advertisement display method, a terminal device and a non-transitory computer-readable storage medium, wherein the method comprises sending an advertisement data request to a server in a power-on state; receiving the advertisement data returned by the server, wherein the advertisement data includes the advertisement data of the day when the advertisement data request is sent and of a predetermined number of days after the day; downloading advertisement materials according to the advertisement data; selecting an advertisement material for display upon the next power-on event.

### CROSS REFERENCE TO RELATED APPLICATIONS

This disclosure is a continuation of International Application No. PCT/CN2016/088647, filed on Jul. 5, 2016, which is based upon and claims the priority of China patent application No. 201510954189.2, titled as “Advertisement display method and system, terminal device and server”, submitted to China Patent Office on Dec. 17, 2015, which is incorporated herein by reference in its entirety.

### TECHNICAL FIELD

The disclosure relates to the field of intelligent terminals, in particular to an advertisement display method, a terminal device and a non-transitory computer-readable storage medium.

### BACKGROUND

Advertisements have relatively stricter requirements for real-time property, and thus most are real-time requests. Advertisement display is classified into within-schedule display and out-of-schedule display. Out-of-schedule advertisement display may not contribute to sales settlement, and the delivery effect is greatly reduced or insignificant. In case that the within-schedule advertisement display is unable to or unsuitable for real-time requests, for example, boot advertisements of the internet TV, there is a need for certain means to improve the exposure of within-schedule advertisements.

In case of current technologies, as limited by material sizes and inaccessibility to the internet during display, what displayed as the boot advertisement is an off-line advertisement downloaded upon the previous power-on event. If the date when the off-line advertisement is broadcast is inconsistent with the scheduling date when this off-line advertisement is downloaded, the off-line advertisement will be displayed as an out-of-schedule advertisement. If the advertisement delivery schedule is successive, it will only affect the advertisement display of the day when the first power-on event occurs. Calculated on that a user executes the power-on operation 3 times a day on average, on the first day of delivery, if the material is downloaded successfully, the proportion of invalid displayed advertisements accounts for ⅓ in theory, thus the loss ratio of effectively scheduled advertisements is very high. In reality, advertisers generally select delivery at intervals. Accordingly, the overall loss ratio will be higher.

### SUMMARY

Considering the above problems, the present disclosure has been made to provide an advertisement display method and system, a terminal device and a server, to overcome, at least in part, the above problems.

According to one aspect of the disclosure, there is provided with a display method of advertisement data, which includes: sending an advertisement data request to a server in a power-on state; receiving the advertisement data returned from the server, the advertisement data including advertisement data of a day when the advertisement data request is sent and of a predetermined number of days after the day; downloading advertisement materials according to the advertisement data; selecting an advertisement material for display upon the next power-on event.

According to another aspect of the present disclosure, there is provided with a terminal device, which includes: at least one processor, and a storage which stores at least one program. When at least one program is run by at least one processor and enable the at least one processor to: send an advertisement data request to a server in a power-on state; receive the advertisement data returned from the server, the advertisement data including advertisement data of a day when the advertisement data request is sent and of a predetermined number of days after the day; download advertisement materials according to the advertisement data; selecting an advertisement material for display upon the next power-on event.

According to a further aspect of the disclosure, there is provided with non-transitory computer-readable storage medium which storing computer executable instruction. The computer executable instruction is used for sending an advertisement data request to a server in a power-on state; receiving the advertisement data returned from the server, the advertisement data including advertisement data of a day when the advertisement data request is sent and of a predetermined number of days after the day; downloading and storing advertisement materials according to the advertisement data; selecting an advertisement material for display upon the next power-on event.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of the example 1 of an advertisement display method according to the embodiment of the present disclosure;

FIG. 2 shows a functional block diagram of an example of a terminal device according to the embodiment of the present disclosure;

FIG. 3 is a flow chart of the example 2 of an advertisement display method according to the embodiment of the present disclosure;

FIG. 4 shows a functional block diagram of an example of a server according to the embodiment of the present disclosure;

FIGS. 5A and 5B show a functional block diagram of an example of an advertisement data display system according to the embodiment of the present disclosure;

FIG. 6 schematically shows hardware structure of an device for a display method of advertisement according to the embodiment of the present disclosure;

### DETAILED DESCRIPTION

The exemplary embodiments of the present disclosure will be described in more detail below with reference to the accompanying drawings. Although the exemplary embodiments of the present disclosure have been disclosed in the accompanying drawings, it should be appreciated that the present disclosure may be embodied in different forms instead of being limited to the embodiments set forth herein. In contrast, these embodiments are provided so that the present disclosure will be understood more thoroughly and completely, and will fully convey the scope of the present disclosure to those skilled in the art.

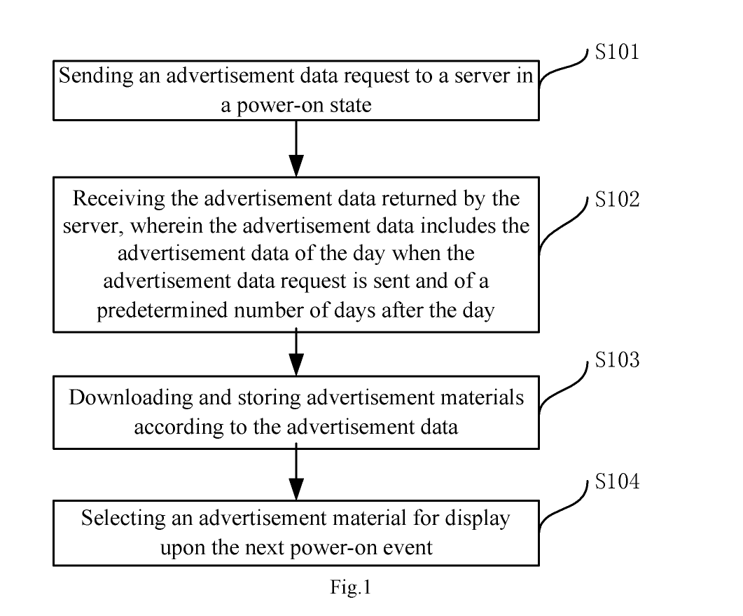

FIG. 1 is a flow chart of the example 1 of the advertisement display method provided by the present disclosure. As shown in FIG. 1, the method specifically includes the following steps:

Step S101, sending an advertisement data request to a server in a power-on state.

The advertisement data includes data such as a link address for downloading advertisement materials and scheduling dates of the advertisement materials. Corresponding advertisement materials may be downloaded via the advertisement data.

Each time a power-on event occurs, an advertisement data request is actively sent to a server after the terminal device and the network are connected. Or, when the time reaches 00:00 of the day, and the terminal device still keeps in the power-on state, the advertisement data request will be actively sent to the server.

Step S102, receiving an advertisement data returned from the sever, wherein the advertisement data includes the advertisement data of the day when the advertisement data request is sent and of a predetermined number of days after the day.

The advertisement data will be returned to terminal device after the server receives the advertisement data request sent by terminal device. The advertisement data includes the advertisement data of the day when the advertisement data request is sent and of a predetermined number of days after the day.

The advertisement data of a corresponding number of days is returned from the server via an advertisement data screening strategy. The basis and method by which the sever sets data screening strategy are shown in the tables below:

TABLE 1

| | | | | | occupation | occupation | occupation | occupation |
|---|---|---|---|---|---|---|---|---|
| | number | | occupation | occupation | ratio of | ratio of | ratio of | ratio of |
| | of | statistic | ratio | ratio of the | two days | three days | four days | five days |
| order | delivery | number | within | day after | after | after | after | after |
| items | days | of days | schedule | schedule | schedule | schedule | schedule | schedule |
| 59972 | 2 | 14 | 86.32% | 97.91% | 98.91% | 99.24% | 99.41% | 99.57% |
| 59972 | 2 | 7 | 86.71% | 97.72% | 98.92% | 99.40% | 99.66% | 100.00% |
| 64650 | 3 | 6 | 88.94% | 99.00% | 100.00% | 100.00% | 100.00% | 100.00% |
| 66095 | 1 | 7 | 75.09% | 97.43% | 98.89% | 99.40% | 99.68% | 99.83% |

As shown in table 1:

Wherein the occupation ratio within schedule refers to a ratio between the exposure number of advertisement within schedule and the total exposure number of advertisement within the statistic period in one statistic period (statistic number of days in the above table).

If the delivery period is 1 day, with reference to the data shown in order item 66095, the data within schedule, i.e., data of [occupation ratio within schedule], is approximately 75%; the data of the second day, i.e., [occupation ratio of the day after schedule] minus [occupation ratio within schedule], 97.43% minus 75.09% is approximately 22.5%; the data of the third day, i.e., [occupation ratio of two days after schedule] minus [occupation ratio of the day after schedule], 98.89% minus 97.43% is approximately 1.5%; the data of the fourth day, i.e., [occupation ratio of three days after schedule] minus [occupation ratio of two days after schedule], 99.40% minus 98.89% is approximately 0.5%; and the occupation ratio of the data of subsequent days is less than 1%.

If the delivery period is 2 days, with reference to two pieces of data shown in order item 59972, the mean value of the data within schedule, i.e., [occupation ratio within schedule], is approximately 86.5%; the mean value of the data of the second day, i.e., [occupation ratio of the day after schedule] minus [occupation ratio within schedule], is approximately 11.5%; the mean value of the third day, i.e., [occupation ratio of two days after the period] minus [occupation ratio of one day after period], is approximately 1%; the mean value of the data of the fourth day, i.e., [occupation ratio of three days after schedule] minus [occupation ratio of two days after schedule], is approximately 0.5%; and the occupation ratio of the data of subsequent days is less than 1%.

If the delivery period is 3 days, with reference to data shown in order item 64650, the data within schedule, i.e., data of [occupation ratio within schedule], is approximately 89%; the data of the second day, i.e., [occupation ratio of the day after schedule] minus [occupation ratio within schedule], is approximately 10%; and the occupation ratio of the data of subsequent days is less than 1%.

According to the above data, it can be seen that in the worst case of advertisement delivery, that is, the delivery period of the advertisement is just 1 day, the occupation ratio of valid data recovered within the subsequent three days may excess 99%; if the delivery period of the advertisement is more than 1 day, the occupation ratio of valid data recovered within the subsequent three days may reach 100%; the occupation ratio of valid data of advertisement exposure 3 days later is less than 1%, wherein the influence of data on advertisement exposure is small and within an acceptable range for advertisers.

According to the above statistics, the advertisement data sent by the server in response to the terminal device is the advertisement data of four days, including the day, and the first day, the second day and the third day after the day, and the advertisement data of each day is advertisement data scheduled on that day.

Step S103, downloading and storing the advertisement materials according to the advertisement data.

After receiving the advertisement data sent by the server, the advertisement data includes the link address and scheduling date of the advertisement materials. Downloading and storing the advertisement materials according to the advertisement data are specifically as follows: downloading and storing the advertisement materials according to the link address and a chronological order of scheduling dates of the advertisement materials. When all the advertisement materials are successfully downloaded, the terminal device uses the received advertisement data returned from the server this time to cover the received advertisement data returned from the server for the last request, so as to save space occupation of the terminal device.

For the downloaded advertisement materials, the terminal device stores and manages the downloaded advertisement materials according to the size of the storage space allocated for the advertisement materials and LRU (Least Recently Used) algorithm. The LRU algorithm refers to that the least recently used data is moved out from the storage space in order to save the storage space occupation of the terminal device. For the downloaded advertisement materials, the storage space is reasonably allocated according to the size of the advertisement material, the size of the storage space of the terminal device and the LRU algorithm; for the downloaded advertisement materials recently least displayed, they are replaced with the newly downloaded advertisement materials.

Step S104, selecting an advertisement material for display upon the next power-on event.

When the terminal device is powered on next time, the advertisement material will be displayed. The selecting of the advertisement material to display is specifically as follows: selecting an advertisement material to display according to the scheduling date of the advertisement material. When a clock module is present in the terminal device, the current system time may be accurately known, and the terminal device is powered on next time, an advertisement material within schedule is selected to display by combining the system time provided by the clock module and scheduling dates of the advertisement materials.

When no clock module is present in the terminal device, and the current system time cannot be accurately known, an advertisement material, as that to display when the next power-on event occurs, is selected with a scheduling date of the day after the advertisement data request is sent. According to statistics, most users will not switch on the terminal device again that day after a particular time, such as 21:00 after closing the terminal device. Thus, after running to a particular time that day, such as 21:00, the terminal device will set an advertisement which will be displayed when the next power-on event occurs as the advertisement for the next day in advance.

According to the advertisement display method provided by the present disclosure, by requesting advertisement data of the day and a predetermined number of days after the day from the server, downloading advertisement materials according to the returned advertisement data, and selecting the advertisement material for display upon the next power-on event, the exposure of within-schedule advertisements is effectively improved, and the delivery of invalid advertisements is reduced.

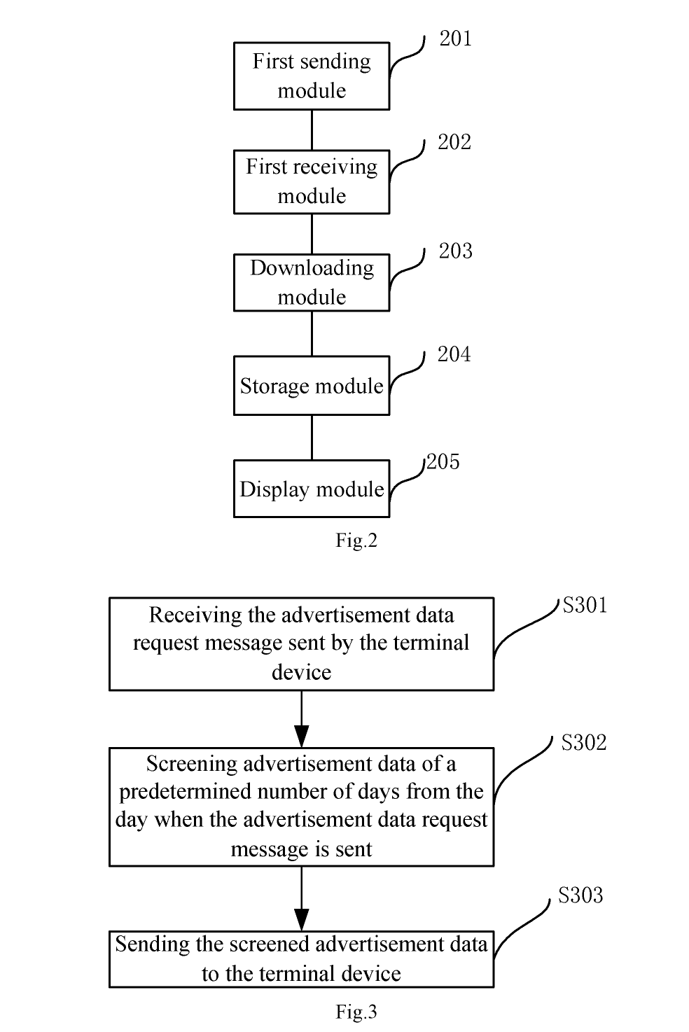

FIG. 2 shows a functional block diagram of an example of a terminal device provided by the present disclosure. As shown in FIG. 2, the terminal device includes:

A first sending module 201 for sending an advertisement data request to a server in a power-on state.

The advertisement data includes data such as a link address for downloading the advertisement material and scheduling dates of the advertisement material. A corresponding advertisement material thereof may be downloaded via the advertisement data.

Each time the power is switched on, the first sending module 201 will always actively send an advertisement data request to the server. Or, when the time reaches 00:00 of the day, and the terminal device still keeps in the power-on state, the first sending module 201 will actively send the advertisement data request to the server.

A first receiving module 202 for receiving the advertisement data returned by the server, wherein the advertisement data includes the advertisement data of the day when the advertisement data request is sent and of a predetermined number of days after the day.

After receiving the advertisement data request sent by the terminal device, the sever will return an advertisement data to the terminal device. The advertisement data includes the advertisement data of the day when the advertisement data request is sent and of a predetermined number of days after the day.

The server returns advertisement data of corresponding number of days through an advertisement data screening strategy. The basis and method by which the server setts the data screening strategy are as shown in table 1.

If the delivery period is 1 day, with reference to the data shown in order item 66095, the data within schedule, i.e., data of [occupation ratio within schedule], is approximately 75%; the data of the second day, i.e., [occupation ratio of the day after schedule] minus [occupation ratio within schedule], 97.43% minus 75.09% is approximately 22.5%; the data of the third day, i.e., [occupation ratio of two days after schedule] minus [occupation ratio of the day after schedule], 98.89% minus 97.43% is approximately 1.5%; the data of the fourth day, i.e., [occupation ratio of three days after schedule] minus [occupation ratio of two days after schedule], 99.40% minus 98.89% is approximately 0.5%; and the occupation ratio of the data of subsequent days is less than 1%.

If the delivery period is 2 days, with reference to two pieces of data shown in order item 59972, the mean value of the data within schedule, i.e., [occupation ratio within schedule], is approximately 86.5%; the mean value of the data of the second day, i.e., [occupation ratio of the day after schedule] minus [occupation ratio within schedule], is approximately 11.5%; the mean value of the third day, i.e., [occupation ratio of two days after the period] minus [occupation ratio of one day after period], is approximately 1%; the mean value of the data of the fourth day, i.e., [occupation ratio of three days after schedule] minus [occupation ratio of two days after schedule], is approximately 0.5%; and the occupation ratio of the data of subsequent days is less than 1%.

If the delivery period is 3 days, with reference to data shown in order item 64650, the data within schedule, i.e., data of [occupation ratio within schedule], is approximately 89%; the data of the second day, i.e., [occupation ratio of the day after schedule] minus [occupation ratio within schedule], is approximately 10%; and the occupation ratio of the data of subsequent days is less than 1%.

Based on the above data, it can be seen that in the worst case of advertisement delivery, that is, the delivery period of the advertisement is just 1 day, the occupation ratio of valid data recovered within the subsequent three days may excess 99%; if the delivery period of the advertisement is more than 1 day, the occupation ratio of valid data recovered within the subsequent three days may reach 100%; further, the occupation ratio of valid data recovered after three days is less than about 1%, which is negligible. According to the above statistics, the advertisement data sent by the server in response to the terminal device is the advertisement data of four days, including the day, and the first day, the second day and the third day after the day, and the advertisement data of each day is advertisement data scheduled on that day.

A downloading module 203 for downloading advertisement materials according to the advertisement data.

After the first receiving module 202 receives the advertisement data sent by the server, the advertisement data includes link address and scheduling dates of the advertisement materials. The downloading module 203 is further used for downloading the advertisement materials according to the link address and a chronological order of scheduling dates of the advertisement materials. After all the advertisement materials have been successfully downloaded, the downloading module 203 uses the received advertisement data returned from the server this time to cover the received advertisement data returned from the server for the last request, so as to save space occupation of the terminal device.

A storage module 204 for storing and managing the advertisement materials according to the size of the storage space allocated for the advertisement materials and LRU algorithm.

For the downloaded advertisement materials, the storage module 204 manages the downloaded advertisement materials according to the size of the storage space allocated for the advertisement materials and LRU (Least Recently Used) algorithm. The LRU algorithm refers to that the least recently used data is moved out from the storage space in order to save the storage space occupation of the terminal device. For the downloaded advertisement materials, the storage space is reasonably allocated according to the size of the advertisement material, the size of the storage space of the terminal device and the LRU algorithm; for the downloaded advertisement materials recently least displayed, they are replaced with the newly downloaded advertisement materials.

A display module 205 for selecting an advertisement material to display upon the next power-on event.

When the terminal device is powered on next time, the advertisement material will be displayed. The display module is further used for selecting an advertisement material to display according to the scheduling dates of the advertisement materials. When a clock module is present in the terminal device, the current system time may be accurately known, and the terminal device is powered on next time, the display module 205 may select an advertisement material within schedule for display by combining system time provided by the clock module and the scheduling dates of the advertisement materials.

If no clock module is present in the terminal device, and the current system time cannot be accurately known, the display module 205 may select an advertisement material, as that to display when the next power-on event occurs, with a scheduling date of the day after the advertisement data request is sent. According to statistics, most users will not switch on the terminal device again that day after a particular time, such as 21:00 after closing the terminal device. Thus, after running to a particular time that day, such as 21:00, the display module 205 will set an advertisement which will be displayed when the next power-on event occurs as the advertisement for the next day in advance.

According to the terminal device provided by the present disclosure, by requesting advertisement data of the day and a predetermined number of days after the day from the server, downloading advertisement materials according to the returned advertisement data, and selecting the advertisement material for display upon the next power-on event, the exposure of within-schedule advertisements is effectively improved, and the delivery of invalid advertisements is reduced.

FIG. 3 is a flow chart of the example 2 of the advertisement display method provided by the present disclosure. As shown in FIG. 3, the method specifically includes the following steps:

Step S301, receiving an advertisement data request message from a terminal device.

The advertisement data includes data such as a link address for downloading advertisement materials and scheduling dates of the advertisement materials. Corresponding advertisement materials may be downloaded via the advertisement data.

The advertisement data request message from the terminal device is received. The advertisement data requested includes a link address for downloading advertisement materials and scheduling dates of the advertisement materials, and so on. Corresponding advertisement materials may be downloaded via the advertisement data.

Step S302, screening advertisement data of a predetermined number of days from the day when the advertisement data request message is sent.

The advertisement data is screened through an advertisement data screening strategy. The screening basis and method are as shown in Table 1.

As shown in Table 1:

Wherein the occupation ratio within schedule refers to a ratio between the exposure number of advertisement within schedule and the total exposure number of advertisement within the statistic period in one statistic period (statistic number of days in the above table).

If the delivery period is 1 day, with reference to the data shown in order item 66095, the data within schedule, i.e., data of [occupation ratio within schedule], is approximately 75%; the data of the second day, i.e., [occupation ratio of the day after schedule] minus [occupation ratio within schedule], 97.43% minus 75.09% is approximately 22.5%; the data of the third day, i.e., [occupation ratio of two days after schedule] minus [occupation ratio of the day after schedule], 98.89% minus 97.43% is approximately 1.5%; the data of the fourth day, i.e., [occupation ratio of three days after schedule] minus [occupation ratio of two days after schedule], 99.40% minus 98.89% is approximately 0.5%; and the occupation ratio of the data of subsequent days is less than 1%.

If the delivery period is 2 days, with reference to two pieces of data shown in order item 59972, the mean value of the data within schedule, i.e., [occupation ratio within schedule], is approximately 86.5%; the mean value of the data of the second day, i.e., [occupation ratio of the day after schedule] minus [occupation ratio within schedule], is approximately 11.5%; the mean value of the third day, i.e., [occupation ratio of two days after the period] minus [occupation ratio of one day after period], is approximately 1%; the mean value of the data of the fourth day, i.e., [occupation ratio of three days after schedule] minus [occupation ratio of two days after schedule], is approximately 0.5%; and the occupation ratio of the data of subsequent days is less than 1%.

If the delivery period is 3 days, with reference to data shown in order item 64650, the data within schedule, i.e., data of [occupation ratio within schedule], is approximately 89%; the data of the second day, i.e., [occupation ratio of the day after schedule] minus [occupation ratio within schedule], is approximately 10%; and the occupation ratio of the data of subsequent days is less than 1%.

Based on the above data, it can be seen that in the worst case of advertisement delivery, that is, the delivery period of the advertisement is just 1 day, the occupation ratio of valid data recovered within the subsequent three days may excess 99%; if the delivery period of the advertisement is more than 1 day, the occupation ratio of valid data recovered within the subsequent three days may reach 100%; the occupation ratio of valid data of advertisement exposure 3 days later is less than 1%, wherein the influence of data on advertisement exposure is small and within an acceptable range for advertisers.

Based on the above statistical results, screening the advertisement data of four days, including the day when the advertisement data request is sent, and the first day, the second day and the third day after the day, and the advertisement data of each day is advertisement data scheduled on that day.

Step S303, sending the screened advertisement data to the terminal device.

The advertisement data screened in step S302 is sent to the terminal device.

The advertisement display method provided according to the disclosure includes receiving an advertisement data request from a terminal device, screening advertisement data of a predetermined number of days from the day when the request is received on the basis of an advertisement data screening strategy, and sending the advertisement data to the terminal device. The screened advertisement data greatly improves the exposure of within-schedule advertisements and reduce the delivery of invalid advertisements.

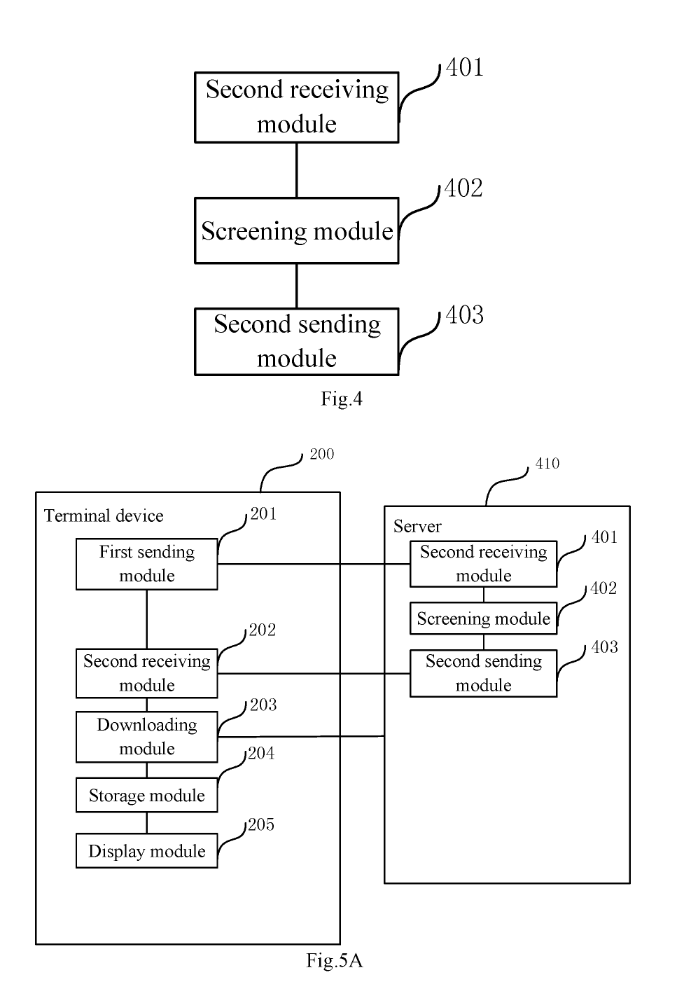

FIG. 4 shows a functional block diagram of an example of the server provided by the disclosure. As shown in FIG. 4, the server includes:

A second receiving module 401 for receiving an advertisement data request message from the terminal device.

The second receiving module 401 receives an advertisement data request message from the terminal device. The advertisement data requested includes a link address for downloading advertisement materials and scheduling dates of the advertisement materials. Corresponding advertisement materials may be downloaded via the advertisement data.

A screening module 402 for screening advertisement data of a predetermined number of days from the day when the advertisement data request message is sent.

The screening module 402 screens advertisement data based on an advertisement data screening strategy. The screening basis and method are as shown in Table 1.

As shown in Table 1:

Wherein the occupation ratio within schedule refers to a ratio between the exposure number of advertisement within schedule and the total exposure number of advertisement within the statistic period in one statistic period (statistic number of days in the above table).

If the delivery period is 1 day, with reference to the data shown in order item 66095, the data within schedule, i.e., data of [occupation ratio within schedule], is approximately 75%; the data of the second day, i.e., [occupation ratio of the day after schedule] minus [occupation ratio within schedule], 97.43% minus 75.09% is approximately 22.5%; the data of the third day, i.e., [occupation ratio of two days after schedule] minus [occupation ratio of the day after schedule], 98.89% minus 97.43% is approximately 1.5%; the data of the fourth day, i.e., [occupation ratio of three days after schedule] minus [occupation ratio of two days after schedule], 99.40% minus 98.89% is approximately 0.5%; and the occupation ratio of the data of subsequent days is less than 1%.

If the delivery period is 2 days, with reference to two pieces of data shown in order item 59972, the mean value of the data within schedule, i.e., [occupation ratio within schedule], is approximately 86.5%; the mean value of the data of the second day, i.e., [occupation ratio of the day after schedule] minus [occupation ratio within schedule], is approximately 11.5%; the mean value of the third day, i.e., [occupation ratio of two days after the period] minus [occupation ratio of one day after period], is approximately 1%; the mean value of the data of the fourth day, i.e., [occupation ratio of three days after schedule] minus [occupation ratio of two days after schedule], is approximately 0.5%; and the occupation ratio of the data of subsequent days is less than 1%.

If the delivery period is 3 days, with reference to data shown in order item 64650, the data within schedule, i.e., data of [occupation ratio within schedule], is approximately 89%; the data of the second day, i.e., [occupation ratio of the day after schedule] minus [occupation ratio within schedule], is approximately 10%; and the occupation ratio of the data of subsequent days is less than 1%.

Based on the above data, it can be seen that in the worst case of advertisement delivery, that is, the delivery period of the advertisement is just 1 day, the occupation ratio of valid data recovered within the subsequent three days may excess 99%; if the delivery period of the advertisement is more than 1 day, the occupation ratio of valid data recovered within the subsequent three days may reach 100%; the occupation ratio of valid data of advertisement exposure 3 days later is less than 1%, wherein the influence of data on advertisement exposure is small and within an acceptable range for advertisers.

Based on the above statistical results, the screening module 402 screens advertisement data of four days, including the day when the advertisement data request is sent, and the first day, the second day and the third day after the day, and the advertisement data of each day is advertisement data scheduled on that day.

A second sending module 403 for sending the screened advertisement data to the terminal device.

The advertisement data screened by the screening module 402 is sent to the terminal device.

The server provided according to the disclosure receives an advertisement data request from a terminal device, screens advertisement data of a predetermined number of days from the day when the request is received on the basis of an advertisement data screening strategy, and sends the advertisement data to the terminal device. The screened advertisement data effectively improves the exposure of within-schedule advertisements and reduces the delivery of invalid advertisements.

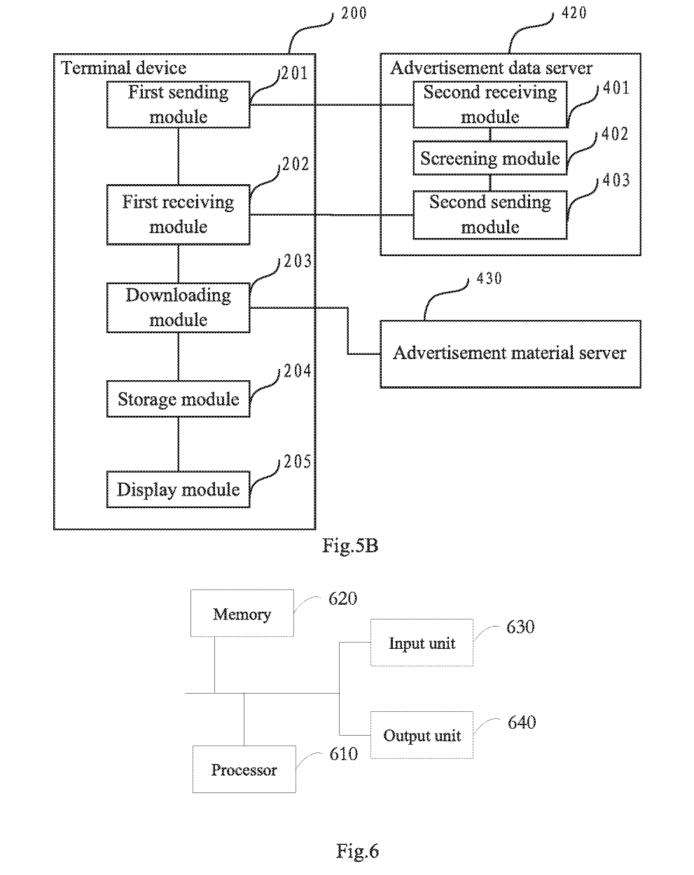

FIGS. 5A and 5B show a functional block diagram of an exemplary advertisement display system provided by the disclosure. Wherein as shown in 5A, the system includes a terminal device 200 and a server 410.

Modules and functions of the terminal device 200 are illustrated as shown in FIG. 2, modules and functions of the server 410 are illustrated as shown in FIG. 4. The first sending module 201 of the terminal device 200 sends an advertisement data request to the server 410, the second receiving module 401 of the server 410 receives the advertisement data request, the server 410 screens, via the screening module 402, advertisement data within a predetermined number of days from the day when the advertisement data request is sent, for example, advertisement data of four days: the day when the advertisement data request is sent, and the first day, the second day and the third day after the day. The second sending module 403 returns the screened advertisement data to the first receiving module 202 of the terminal device 200. After the first receiving module 202 of the terminal device 200 receives the advertisement data from the server 410, the downloading module 203 of the terminal device 200 downloads the corresponding advertisement materials from the server 410 according to the received advertisement data.

Advertisement data and advertisement materials may be stored on the same server, as shown in FIG. 5A, or may be stored on two different servers, as shown in FIG. 5B. The system includes a terminal device 200, an advertisement data server 420 and an advertisement material server 430. A first sending module 201 of the terminal device 200 sends an advertisement data request to the advertisement data server 420. A second receiving module 401 of the advertisement data server 420 receives the advertisement data request, and then the advertisement data server 420, by means of a screening module 402, screens out advertisement data of a predetermined number of days from the day when the advertisement data request is sent, for example, the advertisement data of four days, the day, and the first day, the second day and the third day after the day. The screened advertisement data is returned by a second sending module 403 to a first receiving module 202 of the terminal device 200. After the first receiving module 202 of the terminal device 200 receives the advertisement data sent by the advertisement data server 420, a downloading module 203 of the terminal device 200 downloads corresponding advertisement materials from the advertisement material server 430 according to the received advertisement data.

According to the advertisement display system provided by the present disclosure, by requesting advertisement data of the day and a predetermined number of days after the day from the server, downloading advertisement materials according to the returned advertisement data, and selecting the advertisement material for display upon the next power-on event, the exposure of within-schedule advertisements is effectively improved, and the delivery of invalid advertisements is reduced.

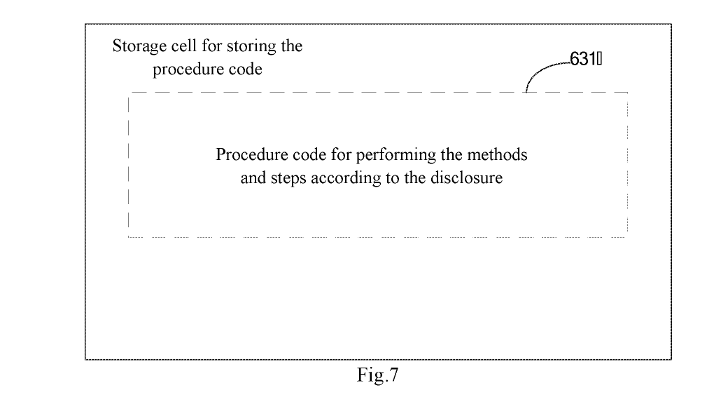

FIG. 6 schematically shows hardware structure of a device for an advertisement displaying method. As shown in FIG. 6, the device includes: one or more processors 610 and memory 620. A processor 610 is showed in FIG. 6 for an example.

A device for an advertisement displaying method can also include: input unit 630 and output unit 640.

Processor 610, memory 620, input unit 630 and output unit 640 can be connected by BUS or other methods, and BUS connecting is showed in FIG. 6 for an example.

Memory 620 can be used for storing non-transitory software program, non-transitory computer executable program and modules as a non-transitory computer-readable storage medium, such as corresponding program instructions/modules for performing an advertisement display method mentioned by embodiments of the present disclosure (such as shown in FIG. 2, first sending unit 201, first receiving unit 202, download unit 203, memory unit 204 and display unit 205, and as shown in FIG. 4, second receiving unit 401, selecting unit 402 and second sending unit 403). Processor 610 performs kinds of functions and data processing of server by executing non-transitory software program, instructions and modules which are stored in memory 620, thereby realizes the advertisement display method mentioned by embodiments of the present disclosure.

Memory 620 can include program storage area and data storage area, thereby the operating system and applications required by at least one function can be stored in program storage area and data created by using the terminal device for the advertisement display method can be stored in data storage area. Furthermore, memory 620 can include high speed Random-access memory (RAM) or non-volatile memory such as magnetic disk storage device, flash memory device or other non-volatile solid state storage devices. In some embodiments, memory 620 can include long-distance setup memories relative to processor 610, which can communicate with the terminal device for advertisement display by networks. The examples of said networks are including but not limited to Internet, Intranet, LAN, mobile Internet and their combinations.

Input unit 630 can be used to receive inputted digital, character information and key signals causing user configures and function controls of the advertisement display method. Output unit 640 can include a display screen or a display device.

The said module or modules are stored in memory 620 and perform the advertisement display method mentioned by any of the embodiments when executed by one or more processors 610.

The said equipment can reach the corresponding advantages by including the function modules or performing the methods provided by embodiments of the present disclosure. Those methods can be referenced for technical details which may not be completely described in this embodiment.

The electronic equipment in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-13. (canceled)

14. An advertisement display method, executed on the side of a terminal device, which comprises:
sending an advertisement data request message to a server in a power-on state;
receiving advertisement data returned by the server, the advertisement data comprises the advertisement data of a predetermined number of days from the day when the advertisement data request message is sent;
downloading and storing advertisement materials according to the advertisement data;
selecting an advertisement material for display upon the next power-on event.

15. The method according to claim 14, wherein, the sending of the advertisement data request message to the server in the power-on state is specifically as follows:
sending the advertisement data request to the server after the power is switched on and a network is connected; and/or
sending the advertisement data request to the server after the time reaches 00:00 in the power-on state.

16. The method according to claim 14, wherein, the advertisement data comprises a link address for downloading the advertisement materials and scheduling dates of the advertisement materials, and
the downloading and storing of the advertisement materials according to the advertisement data are specifically as follows: downloading and storing the advertisement materials according to the link address and a chronological order of scheduling dates of the advertisement materials, and the selecting of the advertisement materials for display is specifically as follows: selecting an advertisement material for display according to the scheduling dates of the advertisement materials.

17. The method according to claim 16, wherein, the selecting of the advertisement materials for display according to the scheduling dates of the advertisement materials comprises:
if a clock module is present, selecting an advertisement material within schedule for display by combining system time provided by the clock module and the scheduling dates of the advertisement materials;
if no clock module is present, selecting an advertisement material, as that to display when the next power-on event occurs, with a scheduling date of the day after the advertisement data request is sent.

18. A terminal device, which comprises:
at least one processor, and
a storage which is communicated by at least one processor.
wherein, the storage stores executable instruction by one processor. The instruction is executed by the at least one processor, and enable the at least one processor to perform:
sending an advertisement data request to a server in a power-on state;
receiving the advertisement data returned from the server, the advertisement data comprising advertisement data of a day when the advertisement data request is sent and of a predetermined number of days after the day;
downloading and storing advertisement materials according to the advertisement data;
selecting an advertisement material for display upon the next power-on event.

19. The terminal device according to claim 18, wherein, the processor further performs: sending the advertisement data request to the server after the power is switched on and a network is connected; and/or sending the advertisement data request to the server after the time reaches 00:00 in the power-on state.

20. The terminal device according to claim 18, wherein, the advertisement data comprises a link address for downloading the advertisement materials and scheduling dates of the advertisement materials.
the processor further performs: downloading the advertisement materials according to the link address and a chronological order of scheduling dates of the advertisement materials; and
selecting an advertisement material for display according to the scheduling dates of the advertisement materials.

21. The terminal device according to claim 20, wherein, the processor further performs: if a clock module is present, selecting an advertisement material within schedule for display by combining system time provided by the clock module and the scheduling dates of the advertisement materials;
if no clock module is present, selecting an advertisement material, as that to display when the next power-on event occurs, with a scheduling date of the day after the advertisement data request is sent.

22. A non-transitory computer storage medium, which stores computer executable instruction. The computer executable instruction is set for:
sending an advertisement data request to a server in a power-on state;
receiving the advertisement data returned from the server, the advertisement data comprising advertisement data of a day when the advertisement data request is sent and of a predetermined number of days after the day;
downloading and storing advertisement materials according to the advertisement data;
selecting an advertisement material for display upon the next power-on event.

23. A non-transitory computer storage medium according to claim 22, wherein, the computer executable instruction is further set for:
sending the advertisement data request to the server after the power is switched on and a network is connected; and/or sending the advertisement data request to the server after the time reaches 00:00 in the power-on state.

24. A non-transitory computer storage medium according to claim 22, wherein, the advertisement data comprises a link address for downloading the advertisement materials and scheduling dates of the advertisement materials. The computer executable instruction is further set for:
downloading the advertisement materials according to the link address and a chronological order of scheduling dates of the advertisement materials; and
selecting an advertisement material for display according to the scheduling dates of the advertisement materials.

25. A non-transitory computer storage medium according to claim 24, wherein, the computer executable instruction is further set for:
if a clock module is present, selecting an advertisement material within schedule for display by combining system time provided by the clock module and the scheduling dates of the advertisement materials;
if no clock module is present, selecting an advertisement material, as that to display when the next power-on event occurs, with a scheduling date of the day after the advertisement data request is sent.
